(19) United States
(12) Patent Application Publication
(10) Pub. No.: US 2008/0023946 A1
(43) Pub. Date: Jan. 31, 2008

(54) Driver Restraining System in a Motor Vehicle

(75) Inventors: Klaus-Dieter Haag, Jettingen (DE); Gerhard Roth, Neuhausen (DE)

Correspondence Address: CROWELL & MORING LLP;INTELLECTUAL PROPERTY GROUP, P.O. BOX 14300, WASHINGTON, DC, 20044-4300, US

(73) Assignee: DAIMLERCHRYSLER AG, Stuttgart (DE)

(21) Appl. No.: 10/587,828

(22) PCT Filed: Dec. 3, 2004
(86) PCT No.: PCT/EP04/13765

§ 371 Date: Apr. 26, 2007

(30) Foreign Application Priority Data
Jan. 30, 2004 (DE) 10 2004 044 710.3

(51) Int. Cl. B60R 21/01

(52) U.S. Cl. 280/735; 280/806

(57) ABSTRACT

In a driver restraining system in a motor vehicle having an airbag which is integrated into a steering device, in the event of a crash, the positioning of the steering device and a triggering decision about the unfolding of the airbag and an unfolding characteristic of the airbag are determined by a control unit whose input signals include a signal of a crash detection sensor system and a signal of a passenger compartment sensor system which has at least one seat position detection means and a sensor system for sensing morphological data of the driver. Furthermore, in the event of a crash, the control unit additionally actuates a motor-operated seat adjustment device of the driver's seat in an adapted fashion.

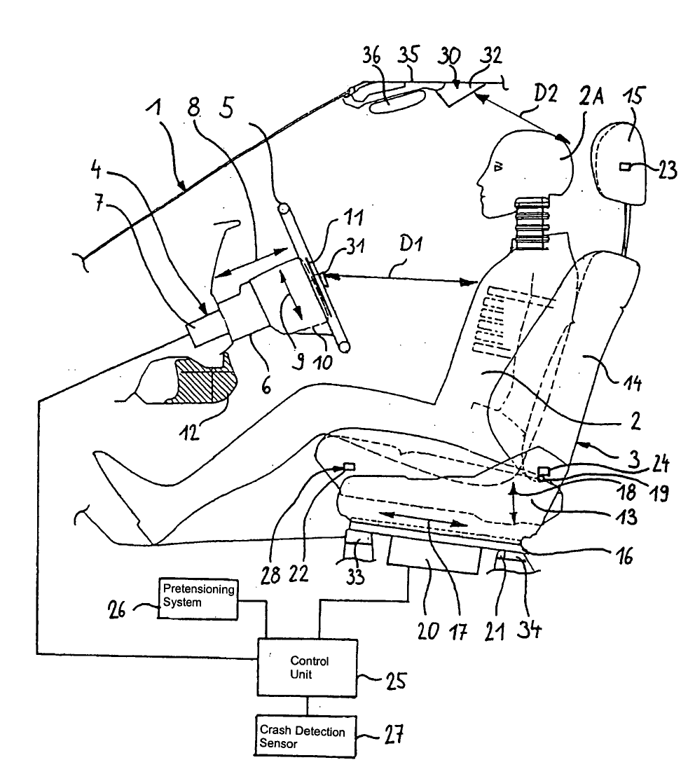

### CROSS REFERENCE TO RELATED APPLICATIONS

This application is a national stage of PCT International Application No. PCT/EP2004/013765, filed on Dec. 3, 2004, which claims priority under 35 U.S.C. § 119 to German Patent Application No. 10 2004 004 710.3, filed Jan. 30, 2004, the entire disclosures of which are herein expressly incorporated by reference.

### BACKGROUND AND SUMMARY OF THE INVENTION

The present invention relates to a driver restraining system in a motor vehicle, having an airbag which is integrated into a steering device. In the event of a crash, the positioning of the steering device, a triggering decision about the unfolding of the airbag and an unfolding characteristic of the airbag are determined by a control unit whose input signals include a signal of a crash detection sensor system and a signal of a passenger compartment sensor system.

Passenger cars and utility vehicles of relatively new design have active and passive safety devices which, in the event of a crash, contribute to reducing the severity of an accident for vehicle occupants and, if appropriate, another party involved in the accident.

In addition to the customary restraining means such as airbags and seatbelts with seatbelt pretensioning devices, the prior art has disclosed other controllable vehicle occupant protection means which have a restraining effect and/or an energy-absorbing effect in order to protect a vehicle occupant in the event of a collision. Examples of this are displaceable impact elements, cushions and headrests whose size, hardness, shape and position can be changed using an actuation means. In order to condition a vehicle occupant for an imminent impact, devices for positioning the vehicle occupant are also used, which may include, for example, a headrest adjustment means and a seatbelt pretensioning device.

The driver is subjected to particular risk by the steering wheel of a motor vehicle. For this reason, the steering device is frequently integrated into a so-called pre-safe system which is already active in a preventative fashion before a possible accident and uses the so-called pre-crash phase, i.e., a period of time starting from the detection of a high probability of an accident by corresponding detection systems up to the actual impact, to protect the vehicle occupant against the consequences of the imminent accident.

Protection of a vehicle occupant by adjusting the steering device to a crash position is known in different embodiments.

For example, GB 2 340 06 A discloses the adjustment of a steering wheel column for ensuring the triggering of an airbag in a linear direction. U.S. Pat. No. 5,984,355 and U.S. Pat. No. 5,507,521 each describe possible ways of changing the angle of the steering wheel in the event of a crash.

However, with these solutions it is disadvantageous that the distance of the driver from the steering wheel and thus from the airbag, which is usually arranged in the central position in the steering column, is not taken into account, or is only inadequately taken into account. As a result, triggering of the airbag when the driver is positioned in the direct vicinity of the steering wheel can, under some circumstances, adversely affects him or her in the event of a crash.

FR 2 761 032 discloses an airbag control device which detects the axial position of the assigned seat and controls the unfolding characteristic of the airbag, in particular the force of the airbag, as a function thereof. Furthermore, it is proposed to provide sensors for sensing morphological data of the passenger located on the seat and to take into account this data in the triggering of the airbag. The described solution provides for a head position of a driver to be determined by means of a sensor on a rear view mirror.

Accordingly, one object of the present invention is to provide a driver restraining system which takes advantage of a steering device that is adjustable in the event of a crash and an airbag which is integrated therein.

Another object of the present invention is to provide such a restraint system that ensures an optimum distance between the driver and the airbag in the event of a crash and achieves an optimum restraining effect of the airbag.

These and other objects and advantages are achieved by the driver restraining system according to the invention, in which an airbag is integrated into a steering device, and in the event of a crash, the positioning of the steering device, a triggering decision about the unfolding of the airbag, and an unfolding characteristic of the airbag are determined by a control unit. The input signals of the control unit include a signal of a crash detector sensor system and a signal of a passenger compartment sensor system which has at least one seat position can, under some circumstances, adversely affect him or her in the event of a crash.

FR 2 761 032 discloses an airbag control device which detects the axial position of the assigned seat and controls the unfolding characteristic of the airbag, in particular the force of the airbag, as a function thereof. Furthermore, it is proposed to provide sensors for sensing morphological data of the passenger located on the seat and to take into account this data in the triggering of the airbag. The described solution provides for a head position of a driver to be determined by means of a sensor on a rear view mirror.

Accordingly, one object of the present invention is to provide a driver restraining system which takes advantage of a steering device that is adjustable in the event of a crash and an airbag which is integrated therein.

Another object of the present invention is to provide such a restraint system that ensures an optimum distance between the driver and the airbag in the event of a crash and achieves an optimum restraining effect of the airbag.

These and other objects and advantages are achieved by the driver restraining system according to the invention, in which an airbag is integrated into a steering device, and in the event of a crash, the positioning of the steering device, a triggering decision about the unfolding of the airbag, and an unfolding characteristic of the airbag are determined by a control unit. The input signals of the control unit include a signal of a crash detector sensor system and a signal of a passenger compartment sensor system which has at least one seat position detection means and a sensor system for sensing morphological data of the driver, In the event of a crash, the control unit additionally actuates a motor-operated seat adjustment device of the driver's seat in an adapted fashion.

The present invention makes use in a simple way of safety and comfort systems which are usually present in any case in modern vehicles, in order to set in an optimum way the distance between the driver and the airbag or its exit flap in the steering wheel in a pre-crash phase. The combined actuation of both the adjustment of the steering wheel, which can be configured in accordance with the manner described in more detail in one of the patents cited at the beginning, a stepped or variable airbag unfolding process and the simultaneous actuation of the motor-operated seat adjustment device permit the driver to be positioned in an optimum way in a significantly shorter time than can be the case when only the steering device is adjusted in a one-sided fashion.

In an advantageous embodiment of the driver restraining system according to the present invention, the sensor system for sensing morphological data of the driver can have at least one weight sensor which is integrated into the driver's seat and which may be a component of a seat occupation detection system which is usually present in any case.

In addition to the weight of the driver, his body size constitutes a significant characteristic variable for bringing about an optimum position of the steering wheel and of the driver's seat, which are adapted to one another, both axially in the longitudinal direction of the vehicle and in height.

For this purpose it is advantageous if the sensor system for sensing morphological data of the driver has at least one sensor which senses the size of the driver and which may sense a position of the head of the driver. This is possible, for example, with the known capacitive sensors which can be arranged in the region of the inner roof lining of a vehicle or of a central rear view mirror or of a headrest.

Further advantages and advantageous refinements of a driver restraining system according to the invention can be found in the description, the drawing and the patent claims.

Other objects, advantages and novel features of the present invention will become apparent from the following detailed description of the invention when considered in conjunction with the accompanying drawings.

### BRIEF DESCRIPTION OF THE DRAWING FIGURES

In the single FIGURE of the drawing, an exemplary embodiment of a driver restraining system according to the present invention is illustrated in basic form and will be explained in more detail in the subsequent description.

### DETAILED DESCRIPTION OF THE DRAWINGS

The FIGURE in the drawing shows a schematic side view of a detail of a driver's area of a motor vehicle 1, a driver 2 being seated on a driver's seat 3 in front of a steering device 4.

Of the steering device 4, a steering wheel 5 and part of a steering column 6 as well as a device 7 for adjusting the steering column 6 and the steering wheel 5 are illustrated schematically. The device 7 for adjusting the steering column 6 can be used here both for adjusting it axially according to an arrow 8 in the FIGURE, adjusting it vertically according to an arrow 9 in the FIGURE and pivoting it.

Furthermore, it is apparent that an airbag 10 is arranged in the steering column 6, centrally with respect to the steering wheel 5, and the exit flap 11 of said airbag is arranged essentially centrally with respect to the steering wheel 5. A so-called knee cushion element 12 is provided underneath the steering device 4 as a further protection device for the driver 2.

The driver's seat 3 has, as main component, a seat lower part 13, a backrest 14 and a headrest 15, the seat lower part 13 being longitudinally adjustable in an axial direction according to an arrow 17 in the FIGURE on seat rails 16 in a known manner. A motor-operated seat adjustment device 20 which is provided for this purpose also permits the driver's seat 3 or the seat lower part 13 and the backrest 14 which is connected thereto by a joint device 19 with an adjustable angle of inclination to be adjusted in height according to the arrow 18.

The axial position of the driver's seat 3 is determined by means of at least one sensor 21 on the seat rail 16, while the vertical position is detected by means of a sensor 22 which is arranged on a seat shell, and the angular position of the backrest 14 is detected by means of a sensor 24 which is arranged on the joint 19. Furthermore, the position of the headrest 15 is determined by means of a sensor 23.

In the embodiment shown, a sensor 31, which is illustrated in enlarged form in the FIGURE and arranged therein on the exit flap 11 of the airbag 10, is provided for sensing a distance D1 of the driver 2 from the steering wheel 5. The sensor 31 can be embodied in any known design of a distance determining sensor but it is particularly advantageous if the sensor 31 is embodied as a capacitive sensor.

All the data of a passenger compartment sensor system 30 which includes these sensors is input into a control unit 25 which, as well as connections, for example, to the sensors 21, 22, 23, 24 of a seat adjustment detection system 28, also has a connection to the electric-motor-operated seat adjustment device 20, to the adjustment device 7 of the steering device 4, to a seatbelt pretensioning system 26 and to a central crash detection sensor 27. When an imminent crash situation is detected by the crash detection sensor 27, an optimum position of the steering device 4 and driver's seat 3 with respect to a distance D1 of the driver 2 from the steering wheel 5 or the airbag exit flap 11 can be set by means of the control unit 25 by actuating further protection devices, in particular the seatbelt pretensioning device 26, in an adapted fashion.

It is useful here that a sensor system for sensing morphological data of the driver 2 is provided which, in order to detect the weight of the driver 2, has weight sensors 33, 34, which here are integrated into the driver's seat 3 and which are at the same time components of a seat occupation detection system.

Furthermore, the sensor system for sensing morphological data of the driver 2 has a sensor 32 which determines the body size of the driver 2 and which, in the embodiment shown, senses a position of the head 2A of the driver 2. The sensor 32 for determining the position of the head 2A can, as shown, be arranged in the region of the inner roof lining 35 of the vehicle or else be integrated, for example, into a central rear view mirror, a sun visor 37 or the headrest 15. The sensor 32 which is used to determine the position of the head can also be advantageously embodied here as a capacitive sensor.

The morphological information about the driver 2 which is acquired in this way constitutes not only important characteristic variables for the positioning of the steering device 4 and driver's seat 3 but is also significant for the selection of an unfolding characteristic, stored in the control unit 25 for a very wide variety of types of drivers, driving states and accident situations, of the airbag 10, which includes not only the unfolding speed and unfolding force but, if appropriate, also the selection and the chronological triggering sequence of airbag stages and an unfolding shape.

Of course, the described functions of the control unit 25 do not all have to be combined in one central control unit but rather can also be processed in decentralized control modules.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1-9. (canceled)

10. A driver restraining system in a motor vehicle, comprising:
an airbag which is integrated into a steering device; and
a control unit whose input signals comprise a signal of a crash detection sensor system and a signal of a passenger compartment which has at least one seat position detector and a sensor system for sensing morphological data of a driver of the vehicle; wherein,
in the event of a crash, positioning of the steering device and a triggering decision about unfolding of the airbag and an unfolding characteristic of the airbag are determined by the control unit; and
in the event of a crash, the control unit adaptively actuates a motor-operated seat adjustment device of a driver's seat.

11. The driver restraining system as claimed in claim 10, wherein the sensor system for sensing morphological data of the driver has at least one weight sensor, which is integrated into the driver's seat and which is a component of a seat occupation detector.

12. The driver restraining system as claimed in claim 10, wherein the sensor system for sensing morphological data of the driver has at least one sensor which determines a size of the driver and which senses a position of the driver's head.

13. The driver restraining system as claimed in claim 12, wherein the sensor for determining the position of the driver's head is arranged in the region of the inner roof lining of a vehicle or of a headrest, the sensor being embodied as a capacitive sensor.

14. The driver restraining system as claimed in claim 10, wherein, in the event of a crash, the motor-operated seat adjustment device sets a vertical position and an axial position of seat elements, including a seat lower part, a backrest and a headrest, as a function of signals of the control unit.

15. The driver restraining system as claimed in claim 10, wherein the passenger compartment sensor system has a sensor for sensing a distance of the driver from a steering wheel of the steering device.

16. The driver restraining system as claimed in claim 15, wherein the sensor for sensing the distance of the driver from the steering wheel is arranged on an exit flap of the airbag.

17. The driver restraining system as claimed in claim 15, wherein the sensor for sensing the distance of the driver from the steering wheel comprises a capacitive sensor.

18. The driver restraining system as claimed in claim 10, wherein, in the event of a crash, the control unit actuates a belt pretensioning device.

19. The driver restraining system as claimed in claim 11, wherein the sensor system for sensing morphological data of the driver has at least one sensor which determines a size of the driver and which senses a position of the driver's head.

20. The driver restraining system as claimed in claim 11, wherein, in the event of a crash, the motor-operated seat adjustment device sets a vertical position and an axial position of seat elements, including a seat lower part, a backrest and a headrest, as a function of signals of the control unit.

21. The driver restraining system as claimed in claim 12, wherein, in the event of a crash, the motor-operated seat adjustment device sets a vertical position and an axial position of seat elements, including a seat lower part, a backrest and a headrest, as a function of signals of the control unit.

22. The driver restraining system as claimed in claim 13, wherein, in the event of a crash, the motor-operated seat adjustment device sets a vertical position and an axial position of seat elements, including a seat lower part, a backrest and a headrest, as a function of signals of the control unit.

23. The driver restraining system as claimed in claim 11, wherein the passenger compartment sensor system has a sensor for sensing a distance of the driver from a steering wheel of the steering device.

24. The driver restraining system as claimed in claim 12, wherein the passenger compartment sensor system has a sensor for sensing a distance of the driver from a steering wheel of the steering device.

25. The driver restraining system as claimed in claim 13, wherein the passenger compartment sensor system has a sensor for sensing a distance of the driver from a steering wheel of the steering device.

26. The driver restraining system as claimed in claim 14, wherein the passenger compartment sensor system has a sensor for sensing a distance of the driver from a steering wheel of the steering device.

27. The driver restraining system as claimed in claim 16, wherein the sensor for sensing a distance of the driver from the steering wheel comprises a capacitive sensor.

28. The driver restraining system as claimed in claim 11, wherein, in the event of a crash, the control unit actuates a belt pretensioning device.

29. The driver restraining system as claimed in claim 12, wherein, in the event of a crash, the control unit actuates a belt pretensioning device.
